(19) United States
(12) Patent Application Publication
(10) Pub. No.: US 2018/0206542 A1
(43) Pub. Date: Jul. 26, 2018

(54) Materials and Methods for Modulation of Insulin Resistance and Gut-Derived Hormones Using Composite Food Products

(71) Applicant: Barry D. Sears, Palm City, FL (US)

(72) Inventor: Barry D. Sears, Palm City, FL (US)

(21) Appl. No.: 15/747,826

(22) PCT Filed: Aug. 4, 2016
(86) PCT No.: PCT/US2016/045533

§ 371 Date: Jan. 26, 2018

Related U.S. Application Data
(60) Provisional application No. 62/205,158, filed on Aug. 14, 2015.
(60) Provisional application No. 62/205,173, filed on Aug. 14, 2015.
(60) Provisional application No. 62/234,829, filed on Sep. 30, 2015.

(51) Int. Cl. A23L 33/185; A23L 33/00; A21D 13/06

(52) U.S. Cl. CPC A23L 33/185; A23L 33/30; A23V 2250/5486; A23V 2002/00; A23V 2200/328; A21D 13/06

(57) ABSTRACT

Specialized high-protein, reduced-carbohydrate edible food products with excellent organoleptic and stability characteristics can be produced which modulate or reduce insulin resistance and increase fat-free mass in a calorie-restricted dietary regimen. These specialized food products, ranging from breads, pasta, pizza dough, tortillas, bagels, pastries, and other similar food products higher in protein and lower in carbohydrate content, have a significant clinical benefit. Modulation or reduction of insulin resistance using such food products has been observed to be clinically relevant and can be used for the treatment of many chronic disease conditions associated with increased insulin resistance.

### CROSS REFERENCE TO RELATED APPLICATIONS

This application claims the benefit of priority under 35 U.S.C. 119(e) from U.S. Provisional Application No. 62/205,158 filed on Aug. 14, 2015, and U.S. Provisional Application No. 62/205,173 filed on Aug. 14, 2015, and U.S. Provisional Application No. 62/234,829 filed on Sep. 30, 2015, the disclosures of which are herein incorporated by reference in their entirety.

### FIELD OF INVENTION

This invention relates to novel high-protein, reduced-carbohydrate composite food products and their uses to reduce insulin resistance and other gut-derived hormones. These dietary products have potential applications in treating medical conditions strongly associated with elevated insulin resistance including obesity, fatty liver disease, polycystic ovary syndrome, diabetes, as well as a variety of other chronic disease states that are related to elevated insulin resistance.

### BACKGROUND OF THE INVENTION

Insulin resistance is defined as the failure of insulin to effectively transmit a signal to the interior of a cell after binding to its receptor. What causes that failure of signal transmission of insulin into the interior of the cell is likely a physiological state of increased inflammation within the cell (Sears and Perry Lipids Dis Health (2015)). Therefore, to modulate and/or reduce insulin resistance likely requires promoting and adhering to an anti-inflammatory diet such as that described in U.S. Pat. No. 6,140,304. However, to follow the teachings of that patent requires disciplined changes in diet that many individuals are unwilling to accept, thus making compliance highly unlikely. In particular, individuals are typically unsuccessful in their efforts to eliminate traditional food products such as breads, pasta, pastries, steamed buns, bagels, cakes, pies, snacks (sheeted, extruded, puffed, fried), cookies, ready-to-eat cereals, tortillas, crackers, chips, and others food items from their daily diets even though such traditional food items contribute to increased systemic inflammation. This is because of their elevated carbohydrate-to-protein ratio and the rapid rate of glucose entry into the bloodstream as a consequence of consuming such traditional products. This increased inflammation generates insulin resistance in various target organs (for example, adipose tissue, liver, and skeletal muscle), which in turn leads to even more detrimental increases in both blood glucose and insulin levels.

To overcome such a problem, it is necessary to make available to consumers specialized food products such as bread, pasta, pastries, and other baked products that have a significantly lower carbohydrate-to-protein ratio as compared to traditional foods which, because of the lower carbohydrate-to-protein ratio contribute to a lower glycemic response and decreased insulin secretion, but which retain the same familiar taste characteristics as the traditional food products they are replacing. U.S. Pat. Nos. 7,691,430 B2 and 9,288,998 B2 demonstrate that it is possible to make such specialized food products. This is important to facilitate adherence to and compliance with a new dietary regimen, which is useful for reducing insulin resistance because these specialized non-traditional food products must be consumed on a continual basis to be effective. Long-term dietary requires that consumers need to remain motivated to include such novel food products in their diet rather than reject them. To date, however, the efficacy of specialized composite food products such as those described in U.S. Pat. Nos. 7,691,430 B2 and 9,288,998 B2 for reducing insulin resistance and various other hormones influenced by the diet has not been demonstrated,

The object of this invention is to develop a successful, consumer-accepted dietary regimen and method of using such specialized food products for the reduction of insulin resistance and changes in other gut-derived hormones.

### SUMMARY OF THE INVENTION

The present invention is directed to use of a specialized food product with a defined macronutrient ratio (carbohydrate-to-protein), which also contains a precisely defined level of a protein component to enable the formation of readily acceptable and palatable food products, which can reduce insulin resistance instead of increasing as well as reducing an individual's susceptibility to develop insulin resistance by changing the levels of other gut-derived hormones such as GLP-1 and PYY.

The unique protein ingredient required for this invention is a modified or unmodified wheat protein in which the disulfide bonds have been broken to confer a non-viscoelastic property to the wheat protein in order to aid in the formation of dough-like products that can be manufactured into specialized food products having taste, texture and palatability features normally associated with much a higher traditional carbohydrate-to-protein ratio. According to a preferred embodiment of the present invention, the total protein content of the final product exceeds 20% of the total weight of the product on a dry weight basis. In another preferred embodiment, the minimum amount of modified wheat protein is greater than 10% of the total protein content of the final form of the specialized food product. In a preferred embodiment, the amount of carbohydrate in the final form of the specialized food product is no more than three times the level of total protein in the final product.

In one aspect, the invention is a method of modulating or reducing insulin resistance comprising the step of: consuming an effective amount of a specialized edible food product comprising a minimum of 10% modified or unmodified wheat gluten as percentage weight of the total protein of the product, but not exceeding 75% of the total protein content of the final edible product.

In a currently preferred embodiment, the ratio of carbohydrate to total protein of the final edible product is less than 3:1 by weight.

In certain embodiments of the invention, the final edible product used to modulate or reduce insulin resistance is selected from the group consisting of: breads, rolls, pizza crusts, bagels, pastas, tortillas, chips, and pastries.

In yet another preferred embodiment, the method can modulate or reduce insulin resistance when the final edible food product is consumed within a regimen of calorie-restricted intake. This is exemplified elsewhere herein.

In a currently preferred method, the method can cause a gain in fat-free mass within a regimen of calorie-restricted intake. This is exemplified elsewhere herein.

When used in accordance with the teachings and guidelines set forth herein, the present method is useful in the treatment of metabolic disorders selected from the group consisting of: obesity, metabolic syndrome, fatty liver, diabetes, and insulin-resistance chronic diseases. For example, but not limited to, such insulin-resistant chronic diseases are selected from the group consisting of: heart disease, polycystic ovary syndrome, cancer, and Alzheimer's Disease.

In another aspect of the invention, a specialized edible food product for modulating or reducing gut-derived hormones comprises a minimum of 10% modified or unmodified wheat gluten as percentage weight of the total protein of the product, but not exceeding 75% of the total protein content of the final edible product. In a currently preferred embodiment, the ratio of carbohydrate to total protein of the final edible product is less than 3:1 by weight. In certain embodiments of the invention, the final edible product used to modulate or reduce insulin resistance is selected from the group consisting of: breads, rolls, pizza crusts, bagels, pastas, tortillas, chips, and pastries.

In another aspect of the invention, a method of modulating or reducing gut derived hormones comprising the step of: consuming an effective amount of a specialized edible food product comprising a minimum of 10% modified or unmodified wheat gluten as percentage weight of the total protein of the product, but not exceeding 75% of the total protein content of the final edible product. In a currently preferred embodiment, the gut derived hormones are selected from the group consisting of: GLP-1 and PPY. In yet another aspect of the invention, the specialized edible food product modulates or reduces GLP-1 or PPY.

Specialized food products according to the teachings of this invention can be used in a standardized diet with high compliance to reduce insulin resistance as well as modulate other gut-derived hormones. The use of these specialized dietary food products is applicable to treating a large number of chronic disease conditions ranging from obesity to diabetes. Moreover, related conditions in which insulin resistance is a major factor in their development can also be modulated and treated using the methods of the present invention. Such related conditions include fatty liver, polycystic ovary syndrome, cardiovascular disease, hypertension, stroke, Alzheimer's disease, and other diseases associated with elevated insulin resistance. Thus reducing insulin resistance with the materials and methods of the present invention can be a major factor in their modulation and treatment of those chronic diseases associated with insulin resistance.

While it is known that a reduction of calories can eventually contribute to a reduction in insulin resistance, the discoveries underlying the present invention are unexpected. The present invention provides dietary products, which when used in a calorie-restricted diet results in a statistically significant greater reduction in insulin resistance and modulation of gut-derived hormones compared to an isocaloric control diet, as well as greater increases in muscle mass during the same time period.

### DETAILED DESCRIPTION

This invention is directed to a method of modulating or reducing insulin resistance and increasing fat-free mass on a calorie-restricted diet.

Specialized food products according to the teachings of this invention can be used in a standardized diet with high compliance to reduce insulin resistance. The use of these specialized dietary food products is applicable to treating a large number of chronic disease conditions ranging from obesity to diabetes. Moreover, related conditions in which insulin resistance is a major factor in their development can also be modulated and treated using the methods of the present invention. Such related conditions include fatty liver, polycystic ovary syndrome, cardiovascular disease, hypertension, stroke, Alzheimer's disease, and other diseases associated with elevated insulin resistance. Thus reducing insulin resistance with the materials and methods of the present invention can be a major factor in their modulation and treatment.

The studies exemplified herein demonstrate that under the conditions of calorie restriction, the unique composition of the specialized food products disclosed herein can improve insulin resistance to a much greater degree than would be observed at the same level of calorie restriction. Thus the studies exemplified herein demonstrate that moderate calorie restriction to induce weight loss is often insufficient to successfully reduce insulin resistance. However, the inclusion of the products of this invention as part of the moderate calorie-restricted diet will successfully reduce insulin resistance as well as increase fat-free mass. In addition, an even more severe calorie-restriction does not result in any better reduction of insulin resistance. This is the focus of the present invention.

While it is known that a reduction of calories can eventually contribute to a reduction in insulin resistance, the discoveries underlying the present invention are unexpected. The present invention provides dietary products, which when used in a calorie-restricted diet results in a statistically significant greater reduction in insulin resistance compared to an isocaloric control diet, as well as greater increases in muscle mass during the same time period.

Insulin is the primary regulator of carbohydrate, fat, and protein metabolism. Insulin inhibits lipolysis of stored fat in the adipose tissue, it inhibits gluconeogenesis in the liver, it stimulates the translocation of the GLUT-4 protein to bring glucose into the muscle cells, it stimulates gene expression of proteins required for the optimal cellular function as well as cellular repair and growth, and it indicates the metabolic availability of various fuels to the brain. Therefore keeping insulin within a therapeutic zone is critical for our survival.

Although the definition of insulin resistance is deceptively simple (a condition in which cells are no longer responding appropriately to circulating insulin), the molecular causes of insulin resistance are diverse and extremely complex. What is known is that once insulin resistance is established causing metabolic dysfunction becomes apparent in the wide number of organs including the adipose tissue, liver, and skeletal muscles. Therefore reducing insulin resistance is the primary therapeutic approach in the treatment of many disease conditions that are associated with insulin resistance. These chronic conditions include obesity, metabolic syndrome, diabetes, fatty liver, heart disease, hypertension, stroke, cancer, polycystic ovary syndrome, and Alzheimer's disease to name but a few.

The present invention is based on the discovery that continued use of specialized food products as described in U.S. Pat. Nos. 7,691,430 B2 and 9,288,998 B2, which describe manufacture of an extensible composite food material comprising a combination of non-modified and modified wheat protein and other ingredients, can modulate and/or reduce weight loss, muscle gain, and reduction of insulin resistance.

In a preferred embodiment, the ratio of carbohydrates-to-protein in the specialized food products used in this invention is less than 3:1 by dry weight in the final product. The blending of the ingredients with adequate amounts of liquid such as but not limited to water permits formation of a protein-rich dough with a controlled extensibility that can then be molded, extruded, die cut, laminated, direct deposited or manipulated using other standard techniques for subsequent baking, drying, microwaving, frying, boiling, or a combination thereof. There is the option of adding topical seasonings or coatings for the final product. The skilled practitioner will understand how to accomplish such dough using routine skill in the art and general knowledge in the art when following the teachings of food manufacture in U.S. Pat. Nos. 7,691,430 B2 and 9,288,998 B2.

The following information provides guidance for an appreciation of the science behind the specialized food products set forth in Examples 1-3 herein, as well as in U.S. Pat. Nos. 7,691,430 B2 and 9,288,998 B2 is set forth below:

Gluten is not a single protein, but comes from a combination of certain proteins found in selected grains that under mechanical stress in an aqueous environment leads to the formation of a three-dimensional elastic dough that can be formed into a wide variety of food products.

Grains that contain the proteins required to produce gluten include wheat, rye, barley, spelt, bulgur and others. Since wheat is the primary source of the proteins to make gluten, the rest of this discussion will focus on wheat proteins.

Wheat proteins fall into four distinct categories:
1. Albumins that are soluble in water
2. Globulins that are soluble in dilute salt solutions
3. Prolamins that are soluble in 70% alcohol solutions, but not in water or absolute alcohol
4. Glutenins that are insoluble in water and neutral salt solutions, but are soluble in acidic and basic solutions.

The two wheat protein components required to make wheat gluten are gliadins (prolamins) and glutenins. These two proteins are the primary storage proteins in wheat and make up about 80-85% of the total protein content in wheat. In particular, gliadins comprise about 30-40% of the total wheat protein and glutenins comprise about 40-50% of the total wheat protein. In the presence of water, these two protein fractions can covalently bind to each other through disulfide bridges and other non-covalent interactions thus allowing the formation of dough that has unique elastic characteristics that allow it to be formed into a wide variety of shapes for the production of various food products. The present invention contemplates that these elastic characteristics, however, are modified and controlled in order to prepare the specialized food products used in the present invention. However, dough extensibility is an essential feature for ultimately producing the edible specialized food products referenced herein.

Gliadins are rich in sulfur-containing cysteine amino acids that are essential for the viscosity and extensibility of final gluten-containing product. The number of reactive sulfur linkages can be increased by incubation of gliadin-containing wheat protein fraction in the presence of reducing agents such as L-cysteine, glutathione, non-leavening yeast and others. This incubation during the mechanical mixing process will break down some of the disulfide linkages in gluten that can be reformed again during the baking or extrusion processing. Such modified wheat proteins are important in the production of products that require high levels of extensibility.

Furthermore, the higher concentration of sulfur-containing amino acids in the invention allows for greater protein crosslinking in the final product. The increased protein crosslinking allows for the formation of protein “cages” that can encapsulate the remaining carbohydrate in the product. As a result, both the protein and carbohydrate ingredients in the product enter the blood at a slower rate. In addition, the cross-linking of the protein delays the absorption of the protein so that it is absorbed in lower levels of the gut where the L-cells of the intestinal lining are more concentrated. The L-cells are the ones that release gut hormones (such as GLP-1 and PYY). The result is a significant modulation of both insulin and other gut-derived hormones upon continued use of the invention.

Glutenins allow the dough to hold its shape during mechanical stress and non-mechanical stress such as increases in volume during cooking or extrusion.

As discovered and disclosed herein, the combination of gluten with other proteins, carbohydrates, and fats permits fabrication and production of unique food products that can reduce insulin resistance and enhance muscle mass as evidenced by the Examples which follow below.

### EXAMPLES

### Product Preparation: Example 1

66 grams of wheat flour consisting of approximately 6.5 grams of gluten-protein, 8.5 grams of wheat protein isolate consisting of approximately 7.2 grams of gluten-protein, 10.7 grams of a wheat protein concentrate consisting of approximately 7.5 grams of gluten-containing protein, 13 grams of milk protein isolate, and 1.3 grams of salt were blended together for 1 minute in a stainless steel single arm dough mixer. To this dry powder mixture was added 50 ml of warm water (60-72 F) with 3 grams of baker's yeast. The resulting mixture was blended for 8 minutes. The resulting dough was divided and rounded to form dough balls. The dough balls were approximately 60 grams with a dry weight (dry matter basis) of 35.6 grams. The dough balls were placed on a pan and then transferred to a proofer for 30-60 minutes to let the dough rise. The resulting material was then baked at 350 F for 8-12 minutes to produce a bread product whose final dry composition consisted of 16 grams of total protein of which 12.0 grams were gluten-containing protein and 21.6 grams of total carbohydrate.

### Product Preparation: Example 2

10.6 grams of wheat flour consisting of approximately 0.9 grams of gluten-containing protein, 8.4 grams of a wheat protein isolate consisting of 6.3 grams of gluten-containing protein, 10.4 grams of a wheat protein concentrated consisting of approximately 6.4 grams of gluten-protein, 56 grams of corn masa flour, 13 grams of milk protein isolate, 13.2 grams of lard, and 1.3 grams of salt were blended together for 1 minute in a stainless steel single arm dough mixer. To this dry mixture was added 76 ml of water and mixed for another 10 minutes. The resulting dough was then pressed into tortillas and baked for 45-60 seconds at 600 F. The resulting corn tortilla of 56 grams total weight (32% moisture) that contained 12.0 grams of protein of which 4.4 g were gluten-protein, and 19.0 grams of total carbohydrate.

### Product Preparation: Example 3

63 grams of durum semolina wheat consisting of approximately 5.9 grams of gluten-containing protein, 19 grams of wheat protein isolate consisting approximately 14.8 grams of gluten-containing protein, 10 grams of a wheat protein concentrate consisting of approximately 6.7 grams of gluten-containing protein, 4.2 grams of egg white powder, 1.8 grams of lecithin, 1.3 grams of sodium alginate, 3.9 grams of high oleic sunflower oil, and 0.7 grams of salt were blended together for 1 minute in a stainless steel single arm dough mixer. To this dry mixture was added 18 ml of water and mixed for another 10 minutes. The resulting mixture was then extruded using the appropriate die from a pasta extruder and cut into individual pieces. The pasta pieces were dried so that resulting water content was reduced to 10% of total weight. One 60 gram serving of this pasta contains 20.0 grams of protein of which 13.5 g were gluten-protein and 28.2 grams of total carbohydrate.

### Reduction of Insulin Resistance: Example 4

Although significant calorie restriction will reduce insulin resistance the following study was conducted to demonstrate the unique ability of the invention to reduce insulin resistance compared to a control diet with equal calorie restriction.

Twenty obese, non-diabetic subjects were recruited for a feeding trial using the pasta described in Example 3. Their average weight was 94 kg and average BMI was 32. These subjects were split into two groups, one group receiving two prepared meals per day containing the pasta described in Example 3 and the group receiving the same two meals of equivalent calorie content but using gluten-free pasta instead of the pasta described in Example 3.

Both sets of pasta meals were prepared in a metabolic kitchen so that the subjects could not tell the difference between them. These prepared meals were supplemented with a defined meal plan for both groups that was otherwise identical. 3-day dietary recalls indicate that both groups adhered closely to the plan. The total calorie intake for both groups including the two prepared pasta meals was 2,150 calories per day. This calorie intake was approximately 500 calories per day less than required to maintain their starting weight thus ensuring weight loss during the study. The study was conducted for a total of six weeks.

Insulin resistance was measured using the HOMA method of calculation. At the end of six weeks, there was no statistical difference in the weight loss (−2.2 kg) between the two groups. However, even through the weight loss was the same, the reduction of insulin resistance as measured by HOMA in the group eating the pasta described in Example 3 was 142% greater compared to the control group eating the gluten-free pasta. This difference in the reduction of insulin resistance between the two groups was statistically significant (p=0.02).

### Reduction of Insulin Levels: Example 5

The reduction of insulin resistance in Example 4 was also reflected in a similar reduction of plasma insulin levels. Those individuals consuming the pasta described in Example 3 had a 97% greater reduction in plasma insulin compared to the changes in the control eating the gluten-free pasta. This differences was statistically significant (p=0.02)

### Reduction in GLP-1 Levels: Example 6

GLP-1 is one of the gut hormones released from the L-cells in the gut in response to protein. Fasting GLP-1 levels are higher in obese subjects with a fatty liver compared to obese subjects with a normal liver. In the study described in Example 4, the decrease in GLP-1 levels significantly reduced after six weeks in the subjects consuming the pasta described in Example 3 compared the subjects consuming the gluten-free control pasta whose GLP-1 levels actually rose. The differences between the changes in GLP-1 levels were statistically significant (p=0.02)

### Changes in PYY Levels: Example 7

PYY is another gut hormone that is released from the L-cells that are exposed to protein. The changes in PYY levels were highly correlated (p=0.003) with the changes in the GLP-1 levels in the subjects in the study described in Example 4.

The TG/HDL ratio is can be used as a surrogate marker of a fatty liver. The changes in the PYY levels were significantly correlated to the changes in the TG/HDL ratio (p=0.045) in the subjects in the study described in Example 4.

### Gain of Fat-Free Mass with Calorie Restriction: Example 8

One of the common side effects of a calorie restricted diet is the loss of fat-free mass commonly described as muscle mass. Although the weight loss of the two groups described in Example 4 was the same (−2.2 kg), the subjects eating the pasta described in Example 3 had an increase in fat-free mass (+1.7 kg) during the six weeks of calorie restriction, whereas those consuming the gluten-free past lost (−0.4 kg) of fat-free mass. This result was statistically significant (p<0.02). The change in fat-free mass was inversely correlated with the change in insulin resistance (p=0.02)

### Comparison to Other Calorie-Restricted Studies: Example 9

Generally, the more severe the calorie restriction in obese individuals, the greater the reduction of insulin resistance as measured by HOMA. The results in our six-week study described in Examples 4 and 5 can be compared to a recent clinical study (Watson et al. Nutrients 8:269 (2016)) that used a more severe calorie restriction for a greater duration (12 weeks) in obese individuals using two different diet compositions. This was a greater degree of calorie restriction and longer duration than the study described in Example 3. Therefore the results should have been greater than the results in Example 3. The diet composition differences between the two studies are compared in Table 1.

TABLE 1

| | Example 3: | Example 3: | | |
|---|---|---|---|---|
| | Control | Active | Watson et al: | Watson et al: |
| Parameter | Group | Group | High Carb | High Protein |
| Total | 2119 | 2160 | 1420 | 1490 |
| calories | | | | |
| (per day) | | | | |
| % Protein | 15 | 23 | 21 | 29 |
| % Carbs | 52 | 42 | 50 | 35 |
| % Fat | 33 | 36 | 22 | 30 |
| Protein (g/d) | 82 | 124 | 75 | 108 |
| Carbs (g/d) | 273 | 226 | 178 | 134 |
| Fat (g/d) | 78 | 86 | 35 | 50 |

From Table 1 it can be observed that macronutrient composition of the active group in Example 3 was midway between the compositions of the two diets used in the Watson et al. study. Furthermore both groups in Example 3 were consuming nearly 50% more calories on a daily basis than in the Watson et al. study.

Although average weight loss (−7.8 kg) was greater in the Watson et al. study than the average weight loss (−2.2 kg) in Example 3. This can be explained by the greater extent of calorie restriction (average of 1,455 vs. average of 2,140 calories per day) for a longer period of time (12 weeks vs. 6 weeks). However, as in Example 3, there was no statistically significant difference between the magnitudes of weight loss in the groups in both studies.

On the other hand, there was a statistically significant difference between the gain of fat-free mass and simultaneous reduction of insulin resistance of the active diet vs. the control diet as described in Example 4 and 5. For comparison, there were no significant differences in the changes in muscle mass or insulin resistance between the two diets used in the Watson et al study.

In particular, the subjects in the Watson et al. study had an average reduction of HOMA of 38% in both groups, but there was no significant difference between the two groups. On the other hand, the reduction of insulin resistance of the active group of Example 3 was 33% with far less calorie restriction and shorter period; this reduction was significant compared to the placebo group in Example 4 even though there was no significant differences in total weight loss between the two groups.

In addition, the average reduction of fat-free mass was −1.5 kg in the Watson study, where as those in the active group in Example 5 gained 1.7 kg of fat-free mass while the placebo group in Example 5 lost a significant amount of fat-free mass (−0.4 kg). This loss of fat-free mass was even greater for both diet groups in the Watson study.

The significant changes in fat-free mass and reduction of insulin resistance are unexpected results coming from use the specialized food products. This illustrates the unique and heretofore undescribed properties of the invention to reduce insulin resistance, modulate insulin and gut-derived hormones, and simultaneously cause a gain in fat-free mass under conditions of calorie restriction.

1. A method of modulating or reducing insulin resistance comprising the step of: consuming an effective amount of a specialized edible food product comprising a minimum of 10% modified or unmodified wheat gluten as percentage weight of the total protein of the product, but not exceeding 75% of the total protein content of the final edible product.

2. The method of claim 1 wherein the ratio of carbohydrate to total protein of the final edible product is less than 3:1 by weight.

3. The method of claim 1 or 2 wherein the final edible product is selected from the group consisting of: breads, rolls, pizza crusts, bagels, pastas, tortillas, chips, and pastries.

4. The method of claim 3 which can modulate or reduce insulin resistance when the edible food product is consumed within a regimen of calorie-restricted intake.

5. The method of claim 3 which can cause a gain in fat-free mass within a regimen of calorie-restricted intake.

6. The method of claim 4 wherein the modulation or reduction of insulin resistance is useful in the treatment of metabolic disorders selected from the group consisting of: obesity, metabolic syndrome, fatty liver, diabetes, and insulin-resistance chronic diseases.

7. The method of claim 6 wherein the insulin-resistant chronic diseases are selected from the group consisting of: heart disease, polycystic ovary syndrome, cancer, and Alzheimer's Disease.

8. A specialized edible food product for modulating or reducing insulin resistance corresponding to the edible food product of claim 1 or 2.

9. A specialized edible food product for modulating or reducing insulin resistance corresponding to the edible food product of claim 3.

10. A specialized edible food product for modulating or reducing insulin levels corresponding to the edible food product of claim 3.

11. A method of modulating or reducing gut derived hormones comprising the step of: consuming an effective amount of a specialized edible food product comprising a minimum of 10% modified or unmodified wheat gluten as percentage weight of the total protein of the product, but not exceeding 75% of the total protein content of the final edible product.

12. The method of claim 11 wherein the gut derived hormones are selected from the group consisting of: GLP-1 and PPY.

13. A specialized edible food product for modulating or reducing GLP-1 corresponding to the edible food product of claim 12.

14. A specialized edible food product for modulating or reducing PPY levels corresponding to the edible food product of claim 12.
